(19) United States
(12) Patent Application Publication
(10) Pub. No.: US 2003/0035941 A1
(43) Pub. Date: Feb. 20, 2003

(54) Rubber structure and method of making the same

(76) Inventors: Martin P Burke, Hants (GB); Richard Bryant, Hants (GB)

Correspondence Address: Nixon & Vanderhye, 8th Floor, 1100 North Glebe Road, Arlington, VA, 22201-4714, US

(21) Appl. No.: 10/203,926

(22) PCT Filed: Feb. 15, 2001
(86) PCT No.: PCT/GB01/00600

(30) Foreign Application Priority Data
Feb. 16, 2000 (GB) 0003458.7

(51) Int. Cl. B32B 3/00; B32B 3/26

(52) U.S. Cl. 428/315.5; 428/315.7

(57) ABSTRACT

A foamed rubber having a plurality of microvoids comprising mticrospheres incorporated therein characterized in that the microspheres are expanded during heating and vulcanization of the rubber and the volume fraction of the expanded microspheres is 35-80 % in the foamed rubber. The microspheres may be thermoplastic microspheres filled with a volatile liquid. The microspheres may have an unexpanded diameter of 5 to 10 μm and an expanded di ameter of between 300 μm and 1000 μm. Also disclosed is a method of manufacture of a rubber comprising the steps of. providing a rubber; incorporating additives; adding and mixing microspheres into the rubber composition; and heating the rubber to effect vulcanization. The vulcanization of the rubber may be delayed to allow for expansion of expandable microspheres during heating, such a delay may be achieved by adding a delayed action accelerator or a retarder to the rubber.

This invention relates to novel rubbers and a method of making the same. Where the context permits, use of the word “rubber” herein is intended to include synthetic elastomers as well as natural rubber.

Rubber, by virtue of its compliant, elastic nature, is a material well suited to applications requiring impact absorption and vibration damping. In respect of rubber used in applications requiring low intensity vibration damping, e.g. soundproofing, it is desirable that the rubber has a high degree of compliance.

Conventionally, a high degree of compliance can be achieved by foaming rubber. This was first achieved in by Charles Hancock in 1846 (English Patent 11,032) where turpentine and ammonium carbonate were added to gutta percha; the underlying principle being that upon heating, the solvent is driven off and the salt decomposes into gases, causing swelling within the rubber and creating pores. Although substantial refinements have been made to the method since its inception, the basic foaming process remains the same. For example, see U.S. Pat. No. 4,596,684 in which an enhanced method of manufacturing low density foamed rubber is disclosed.

Current foaming processes produce large voids, typically greater than 2 mm in diameter and, unfortunately, such foams have the disadvantage that they perform poorly under pressure, in that application of a pressure on the foam will cause the voids to collapse.

U.S. Pat. No. 6,058,994 describes a method for introducing microspheres of up to 300 μm diameter into a rubber tire tread compound for the purpose of increasing the friction coefficient of the rubber. There is a optimum range for the volume ratio of microspheres in order to improve the abrasion resistance. Below this range, the abrasion resistance is not significantly improved and above it, the abrasion resistance tends to decrease. The optimum void content is 8-20%. The components of the rubber are mixed in an internal mill in a two stage process, with the microspheres, sulphur and vulcanisation accelerator being added in the second stage of mixing. The internal mill subjects the components to high shear which in turn generates heat. These two stages are carried out at a temperature lower than the expansion temperature of the microspheres, by 10 or 15° C., to prevent expansion during the mixing stage. Prematurely expanded microspheres can collapse during subsequent processing.

It is an object of the present invention to produce a compliant rubber with enhanced integrity whilst operating under pressure. Abrasion resistance is not a specific objective.

The current invention was devised primarily for use as an acoustic decoupling or insertion loss material for marine applications. In simple terms such a material acts as a reflector of acoustic energy. The requirements are that the material has both a lower acoustic wave velocity and a lower density than the surrounding medium (i.e. water). These requirements are achieved by incorporating voids into the rubber. High void fractions are required to give high acoustic decoupling performance and enable light weight and highly compliant articles to be made. The compliance and decoupling properties of the foam are optimised by forming microspheres in the 500-1000 cm size range.

The current invention achieves a higher resistance to pressure than gas blown foams since the plastic walls of the microsphere enable the foams to resist compressive deformation. This leads both to improved performance at pressure and improved resistance to permanent deformation (i.e. creep) which can occur when gas blown foams are subjected to compression to extended periods of time (i.e. several weeks or months).

According to a first aspect of the invention, a foamed rubber has a plurality of microvoids comprising microspheres incorporated therein characterised in that the microspheres are expanded during heating and vulcanisation of the rubber and the volume fraction of the expanded microspheres is 35-80% in the foamed rubber. Throughout this specification, microspheres means hollow plastic spheres of diameter 1 μm to 1000 μm within the rubber. The use of microspheres to produce microvoids within the rubber offers a number of advantages over conventional foamed rubbers which use gas voids. When microspheres are employed, the voids have a wall which imparts stiffness to the rubber and enables the rubber to be used at higher pressures than conventional foamed rubbers.

Preferably, the rubber has a range of microvoid sizes incorporated therein. This can be achieved by incorporating expandable microspheres, which may be of different sizes, containing different liquids and comprising different surface materials so that on expansion, a variety of void sizes are produced. Expanded microspheres are hollow plastic spheres that do not appreciably change in size during the manufacture of the rubber. They may be made out of a thermoset plastic or may be thermoplastic microspheres that have been heated and thus expanded to a desirable size prior to incorporation into the rubber. Expandable microspheres means hollow plastic spheres which do change in size appreciably during the manufacture of the rubber. They may be made out of thermoplastic materials which expand during the heating phase of the manufacture of the rubber.

Preferably, the volume fraction of microspheres is 40-80% in the vulcanised rubber.

According to a second aspect of this invention, a method of manufacturing a rubber comprises the steps of providing a rubber, incorporating additives, adding and mixing microspheres into the rubber composition and then heating the rubber to effect vulcanisation. The heating step is also conveniently used to expand the expandable microspheres. A variety of different types of microspheres may be used. This process can be used with a variety of natural and synthetic rubber grades. The choice of rubber depends on the properties desired in the final product.

In a preferred embodiment, the step of manipulating the rubber comprises milling. A suitable method is to use a two roll mill where one roll rotates at a faster speed than the other. The rubber will form a sheet around the faster of the two rolls, and the shearing forces encountered at the nip between the rolls enable dispersion of the additives and microspheres in the rubber. Cross cutting of the rubber at regular intervals ensures satisfactory distribution of the additives and microspheres throughout the batch of rubber.

As the inventor has found that the microspheres may begin to expand at 20 to 30° C. below their expansion temperature, it is preferable to use a method of manufacture that does not involve significant heating of the rubber components prior to the vulcanisation process. A milling process, such as is described in the previous paragraph, results in some heating of the components, perhaps from room temperature to 40° C. If the temperature rises much beyond this, the rolls used during milling may be cooled by, for example, water.

Preferably, the microspheres are expandable at suitable temperatures for the vulcanisation of a rubber. This allows the microspheres to be added to the rubber in an unexpanded state which may be more convenient than incorporation of the microspheres in the expanded state, where their volume is over one thousand times greater. It also means that during the vulcanisation process, the expandable microspheres expand, causing a volume increase in the rubber which would help to completely fill the shape of a mould. This could result in less rejected articles either through incomplete filling of a mould or from processing marks on the surface of the rubber.

Preferably, the microspheres are thermoplastic microspheres filled with a volatile liquid. When these expandable microspheres are heated to temperatures above the glass transition temperature of the thermoplastic material used as the skin of the microspheres, the skin becomes soft and easily deformed. This softening of the skin, combined with an increase in gas pressure due to the evaporation of the liquid within the microsphere, which is also a result of the heating process, allows expansion of the microspheres within the rubber. In some circumstances, it may be desirable to incorporate microspheres filled with different volatile liquid or even gases and having different skin materials to obtain a range of sizes of microvoid within the rubber.

The invention will now be described by way of example only with reference to the accompanying figures.

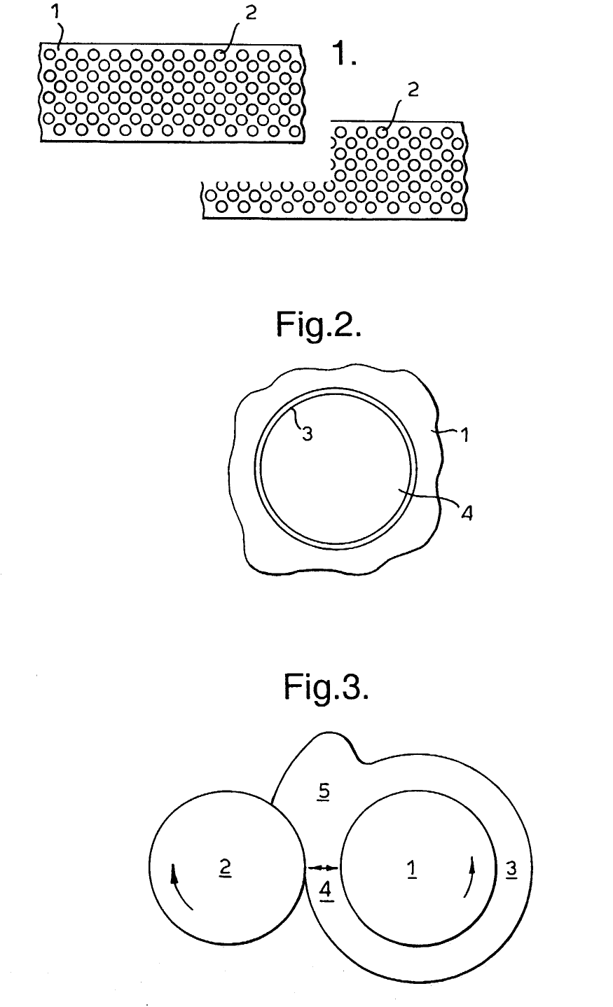

FIG. 1 shows, schematically, a rubber according to the invention

FIG. 2 shows a microvoid of the rubber of figure

FIG. 3 shows, schematically a conventional two roll mill

In FIG. 1, a rubber 1 contains microspheres 2 having a diameter of approximately 400 μm. For the purposes of illustration, the size of the microspheres is greatly exaggerated though, in practice, the microvoids being of 400 μm diameter are barely detectable by the human eye. The rubber has a void fraction of approximately 40%. By manipulating the vulcanisation process, void fractions of 35-60% can be obtained. FIG. 2 shows a microsphere 2 of the rubber of FIG. 1 having a thin wall 3 made from a thermoplastic and containing propane gas 4.

A number of examples of preparing rubber according to the invention will now be described.

Table 1 shows a natural rubber formulation according to the present invention.

TABLE 1

| | Ingredient | Parts by weight |
|---|---|---|
| 1 | Natural Rubber, SMR10 | 100 |
| 2 | Zinc oxide | 5 |
| 3 | Stearic acid | 1 |
| 4 | Accelerator - Cyclohexyl benzthiazyl sulphenamide | 4 |
| 5 | Sulphur | 1 |
| 6 | Retarder - Vulkalent G | 1.5 |
| 7 | Antioxidant - Flectol TMQ | 1 |
| 8 | Microsphere - Expancel 092 DU120 | 3 |

Natural rubber pieces are added to a two roll mill so they form a band around the front roll and are masticated for several minutes. This reduces the viscosity and molecular mass of the rubber. The nip between the rolls is then adjusted to form a rolling bank of rubber. Friction speed is used so that the speed of the front roll is 1.2 times that of the back roll.

A side view of a conventional two roll mill is shown in FIG. 3. The front roll (1) rotates at a faster speed than the back roll (2). The rubber is added in several pieces and forms a band (3) around the front roll. To incorporate additives, the nip or separation between the rolls (4) is decreased until a rolling bank of rubber (5) is formed. The additives (labelled 2-7 in table 1) are then added to the rolling bank into which they are dispersed, followed by addition of the microspheres (labelled 8 in table 1).

Additives labelled 2-6 in table 1 are required for the vulcanisation step of the manufacture of the rubber. Additive 7 is an antioxidant used to extend the service life of the rubber by reducing the effect of oxidation. For this example of a rubber, expandable microspheres are used, additive 8.

When expandable microspheres are used, the vulcanisation process is preferably manipulated to allow the microspheres to expand during the heating step. In order to achieve this delay in the onset of vulcanisation, a delayed action accelerator, additive 4, is used in the rubber formulation. During the delay period, the viscosity of the rubber remains low, allowing the microspheres to expand. The addition of a retarder, additive 6, also assists the expansion process. The retarder gives a useful increase in the induction time without detriment to the final extent of cure. In this example N-cyclohexylthiophthalimide was used as the retarder (Bayer Vulkalent G). Various other retarders can be used such as salicylic acid and Vulkalent E/C.

The additives are mixed into the band of rubber around the front roll but are not mixed into the rolling bank of rubber adjacent to the roll. To give proper mixing, cross cutting is performed. In this process some of the banded rubber layer is cut away from the roll, folded over, and reincorporated around the roll. This has the effect of mixing the banded rubber with the rubber in the bank and repeated cross cutting ensures the additives are distributed uniformly throughout the mix. The mixing process takes approximately 15 minutes. The rubber is then removed from the mill as a sheet.

Rubbers are made using a sulphur vulcanisation mechanism. Vulcanisation involves the generation of chemical cross links between the rubber chains to improve the elasticity of the rubber. The reaction requires several additives. The zinc oxide, additive 2, and stearic acid, additive 3, are required in the vulcanisation reaction and are called activators. An accelerator, additive 4, is used to increase and control the rate of vulcanisation. Sulphur, 5, forms the cross links.

A blank is cut from the sheet that was removed from the roll mill so that it fills typically 60% of the volume of a steel mould. The blank is preferably solid and void free as this is less likely to produce a rejected article when the rubber is removed form the mould. The steel mould is preheated at the pressing temperature of 150° C., while the blank is heated 10 minutes at 100° C. to reduce the thermal lag The blank is then placed in the mould at a temperature of 150° C. and a pressure of 5-10 tonnes applied. The rubber is left in the mould for 70 minutes to allow the microspheres to expand and to vulcanise the rubber. The rubber is then demoulded and allowed to cool on a flat metal surface. The formulation given in table 1, gives void fractions of typically 35-50%in the vulcanised rubber. The void fraction depends on the quantity of rubber used in the mould.

The microspheres preferably have an unexpanded diameter of 5 to 10 μm and an expanded diameter of between 300 μm and 1000 μm. Preferably, the microspheres have an expansion temperature of between 120° C. and 180° C. This allows the microspheres to expand at standard temperatures used for the vulcanisation of a rubber. The expansion temperature is dependent on the glass transition temperature or the melting temperature of the polymer from which the sphere is made.

In a second example, 4 parts of microsphere (additive 8) were used in the formulation given in Table 1. A void fraction of 35-60% was obtained.

Table 2 shows a butadiene rubber formulation according to the present invention. The void fraction for this rubber is typically 40% when the rubber is manufactured under the same conditions as the natural rubber described above.

TABLE 2

| Ingredient | Parts by Weight |
|---|---|
| Buna CB23 Butadiene Rubber | 100 |
| Zinc Oxide | 5 |
| Stearic Acid | 1 |
| Cyclohexyl benzthiazyl sulphenamide accelerator | 1.5 |
| Flectol TMQ Antioxidant | 1 |
| Sulphur | 2 |
| Vulkalent G Retarder | 0.5 |
| Expancel 092 DU120 Microsphere | 3 |

Nitrile rubbers are copolymers of acrylonitrile and butadiene, where the properties of the polymer depend on the amount of acrylonitrile in the polymer chain. Table 3 shows a formulation for a nitrile rubber containing 18% acrylonitrile according to the present invention. The void fraction for this rubber is typically 40% when the rubber is manufactured under the same conditions as the natural rubber described above.

In a further example, 4 parts of microsphere were used in the formulation given in Table 2. The void fraction for this rubber is typically 40-55% when the rubber is manufactured under the same conditions as the natural rubber described above.

TABLE 3

| Ingredient | Parts by Weight |
|---|---|
| Nitrile Rubber Perbunan NT1845 | 100 |
| Zinc Oxide | 2 |
| Stearic Acid | 2 |
| Cyclohexyl benzthiazyl sulphenamide accelerator | 1 |
| Flectol TMQ Antioxidant | 1 |
| Sulphur | 2 |
| Vulkalent G Retarder | 0.5 |
| Expancel 092 DU120 Microsphere | 3 |

Table 4 shows a natural rubber/butadiene rubber blend formulation according to the present invention. The void fraction for this rubber is typically 40% when the rubber is manufactured under the same conditions as the natural rubber described above.

TABLE 4

| Ingredient | Parts by Weight |
|---|---|
| Buna CB23 Butadiene Rubber | 50 |
| SMR-L Natural Rubber | 50 |
| Zinc Oxide | 5 |
| Stearic Acid | 1 |
| Cyclohexyl benzthiazyl sulphenamide accelerator | 1.5 |
| Flectol TMQ Antioxidant | 1 |
| Sulphur | 2 |
| Vulkalent G Retarder | 0.5 |
| Expancel 092 DU120 Microsphere | 3 |

Table 5 shows a formulation according to the present invention for a nitrile rubber containing 34% acrylonitrile. The void fraction for this rubber is typically 35-40% when the rubber is manufactured under the same conditions as the natural rubber described above.

TABLE 5

| | |
|---|---|
| Ingredient | Parts by Weight |

| | |
|---|---|
| Krynac 34.50 Nitrile Rubber | 100 |
| Zinc Oxide | 2 |
| Stearic Acid | 2 |
| Cyclohexyl benzthiazyl sulphenamide accelerator | 2 |
| Flectol TMQ Antioxidant | 1 |
| Magnesium Carbonate Coated Sulphur | 2 |
| Expancel 092 DU120 Microsphere | 3 |

Table 6 shows an isoprene isobutylene rubber (commonly known as butyl rubber) formulation according to the present invention. The void fraction for this rubber is typically 35-40% when the rubber is manufactured under the same conditions as the natural rubber described above.

TABLE 6

| Ingredient | Parts by Weight |
|---|---|
| Butyl 100 Rubber | 100 |
| Zinc Oxide | 3 |
| Stearic Acid | 2 |
| Mercapto benz thiazyl sulphenamide (MBTS) accelerator | 0.25 |
| Tetra methyl thiurum disulphide (TMTD) accelerator | 1 |
| Flectol TMQ Antioxidant | 1 |
| Sulphur | 2 |
| Expancel 092 DU120 Microsphere | 3 |

Rubbers using plastic microspheres are found to give superior performance under hydrostatic pressure, compared to foams containing air or gas voids. Foams with microspheres are less prone to permanent deformation than conventional foams.

1 A foamed rubber having a plurality of microvoids comprising microspheres incorporated therein characterised in that the microspheres are expanded during heating and vulcanisation of the rubber and the volume fraction of the expanded microspheres is 35-80% in the foamed rubber.

2 A foamed rubber according to claim 1 further comprising microvoids with a range of sizes.

3 A foamed rubber according to any preceding claim wherein the microspheres are thermoplastic microspheres containing a volatile liquid.

4 A foamed rubber according to any preceding claim wherein the microspheres have an unexpanded diameter of 5 to 10 μm.

5 A foamed rubber according to any preceding claim wherein the microspheres have an expanded diameter of between 300 μm and 1000 μm.

6 A method of manufacturing a foamed rubber comprising the steps of:
i) providing a rubber;
ii) incorporating additives;
iii) adding and mixing microspheres into the rubber composition; and
iv) heating the rubber to effect vulcanisation.

7 A method according to claim 6 wherein steps ii) and iii) comprise milling.

8 A method according to claim 6 or 7 wherein the microspheres are expandable at suitable temperatures for vulcanisation of a rubber.

9 A method according to claim 8 wherein the vulcanisation of the rubber is delayed to allow for expansion of expandable microspheres.

10 A method according to claim 9 wherein the delay is achieved by adding a delayed action accelerator or a retarder to the rubber.

11 A method according to claims 8 to 10 wherein the microspheres expand at temperatures between 120° C. and 180° C.

12 A rubber made by a method according to claims 6 to 11.
